(19) United States
(12) Patent Application Publication
(10) Pub. No.: US 2019/0291475 A1
(43) Pub. Date: Sep. 26, 2019

(54) SHEET PROCESSING DEVICE AND SHEET MANUFACTURING APPARATUS

(71) Applicant: Seiko Epson Corporation, Tokyo (JP)

(72) Inventor: Tsukasa OTA, Kofu (JP)

(21) Appl. No.: 16/357,551

(22) Filed: Mar. 19, 2019

(30) Foreign Application Priority Data
Mar. 20, 2018 (JP) 2018-052976

(51) Int. Cl. B41J 11/00; B65H 7/02; B65H 5/06; B41J 13/00; B41J 11/60

(52) U.S. Cl. CPC B41J 11/0095; B65H 7/02; B41J 11/007; B41J 13/0009; B41J 11/60; B65H 5/06

(57) ABSTRACT

Provided are a sheet processing device and a sheet manufacturing apparatus capable of accurately processing by a processor at least the printed area of a sheet without excess or deficiency. The sheet processing device has: a conveyor configured to convey a sheet having a printed area that was previously printed; a position detector configured to detect a location of a specific part of the sheet being conveyed by the conveyor; a processor configured to execute a specific process on at least the printed area; a timing predictor configured to predict, based on a detection result from the position detector, the timing when the printed area will reach the processor; and a controller configured to control operation of the processor based on a prediction result of the timing predictor.

### BACKGROUND

### 1. Technical Field

The present invention relates to a sheet processing device and a sheet manufacturing apparatus.

### 2. Related Art

A printer is one example of a device that applies a process to a desired location on sheet media. More specifically, a printer can print on a desired part of a sheet, and in one typical configuration has a conveyance roller for conveying the sheet (conveyed feedstock), a first detector for detecting an amount of conveyance roller rotation, and a second detector for detecting the actual conveyance distance of the sheet by the conveyance roller. See, for example, JP-A-2013-241249.

To improve conveyance precision, the printer described in JP-A-2013-241249 executes a correction process that calculates slippage based on the amount of conveyance roller rotation and the actual conveyance distance so that conveyance precision improves.

Another printer with a different configuration has a conveyance mechanism for conveying sheets (media), a fluid ejection device that ejects a fluid onto the sheet, a first detector that detects the drive distance of the conveyance mechanism, and a second detector that detects the conveyance distance of the sheet. See, for example, JP-A-2016-182694.

To suppress shifting of the landing position of the fluid on the sheet, the printer described in JP-A-2016-182694 adjusts control of at least one of the conveyance mechanism and the fluid ejection device to suppress this shifting based on the drive distance of the conveyance mechanism and the conveyance distance of the sheet.

In the printers described in both JP-A-2013-241249 and JP-A-2016-182694, the conveyance speed may deviate from the design speed, creating a difference between the design value of the conveyance speed and the actual conveyance speed due to such factors as differences (tolerances) in the parts of the printer, and change in the voltage supplied to the printer. When such differences occur, the conveyance timing of sheet conveyance cannot be synchronized with the process timing when the sheet is processed (printed), and accurately processing the sheet without excess or deficiency becomes difficult.

### SUMMARY

An object of the several embodiments of the present invention is to provide a sheet processing device and a sheet manufacturing apparatus capable of accurately applying, without excess or deficiency, a process by a processing device to at least the printing area of a sheet.

The present invention is directed to solving the foregoing problem, and can be embodied as described below.

A sheet processing device according to the invention has a conveyor configured to convey a sheet having a printed area that was previously printed; a position detector configured to detect a location of a specific part of the sheet being conveyed by the conveyor; a processor configured to execute a specific process on at least the printed area; a timing predictor configured to predict, based on a detection result from the position detector, when the printed area will reach the processor; and a controller configured to control operation of the processor based on a prediction result of the timing predictor.

A sheet manufacturing apparatus according to the invention has the sheet processing device according to the invention, and makes new sheets using as feedstock the sheets processed by the processor.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic side view illustrating the configuration of a sheet processing device according to the invention disposed to the upstream side of a sheet manufacturing apparatus according to a first embodiment of the invention.

FIG. 2 is a schematic side view illustrating the configuration of the downstream side of a sheet manufacturing apparatus according to the first embodiment of the invention.

FIG. 3 is a top view of the sheet processing device shown in FIG. 1.

FIG. 4 is a side view of the sheet processing device shown in FIG. 1.

FIG. 5 is a side view of the sheet processing device shown in FIG. 1.

FIG. 6 is a block diagram of the sheet processing device shown in FIG. 1.

FIG. 7 is an enlarged plan view of feedstock that is processed by the sheet processing device shown in FIG. 1.

FIG. 8 is a flow chart describing a control operation of the controller shown in FIG. 6.

FIG. 9 is a flow chart describing a control operation of the controller of a sheet processing device according to a second embodiment of the invention.

FIG. 10 is a schematic side view showing the configuration of a sheet processing device according to a third embodiment of the invention.

FIG. 11 is a schematic top view showing the configuration of a sheet processing device according to a fourth embodiment of the invention.

FIG. 12 is a schematic side view of the sheet processing device shown in FIG. 11.

FIG. 13 is a schematic side view of the sheet processing device shown in FIG. 11.

FIG. 14 is a schematic side view showing the configuration of a sheet processing device according to a fifth embodiment of the invention.

FIG. 15 is a schematic side view showing the configuration of a sheet processing device according to a sixth embodiment of the invention.

FIG. 16 is an enlarged view illustrating fiber and color material in the printed part, and illustrates when a refining prevention agent has been applied to the fiber and color material.

FIG. 17 is an enlarged view illustrating the fiber and color material in the printed part shown in FIG. 16 after passing through a dryer.

### DESCRIPTION OF EMBODIMENTS

Preferred embodiments of a sheet processing device and a sheet manufacturing apparatus according to the invention are described below with reference to the accompanying figures.

### Embodiment 1

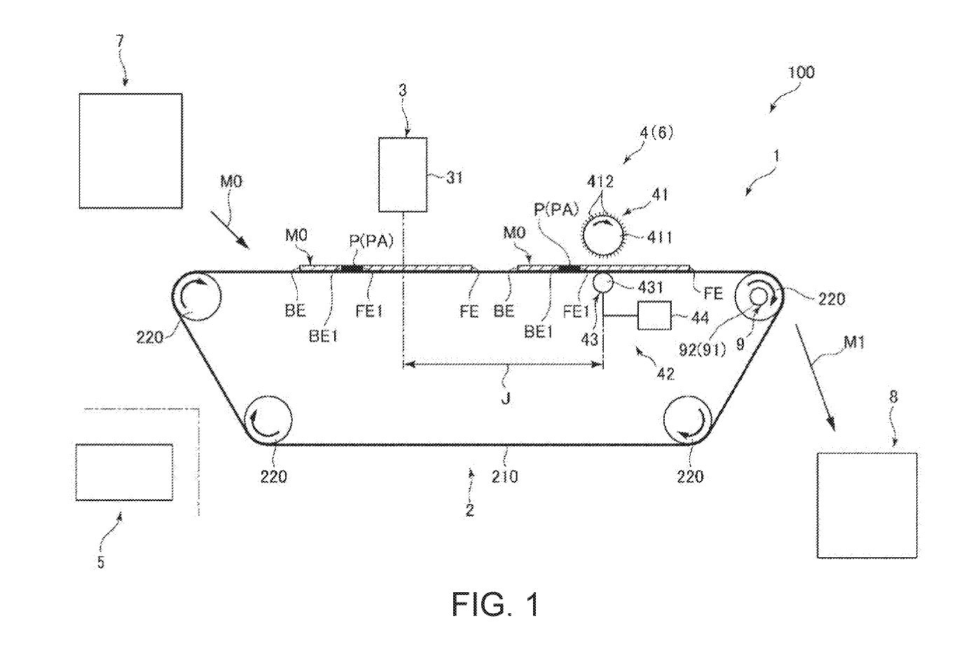

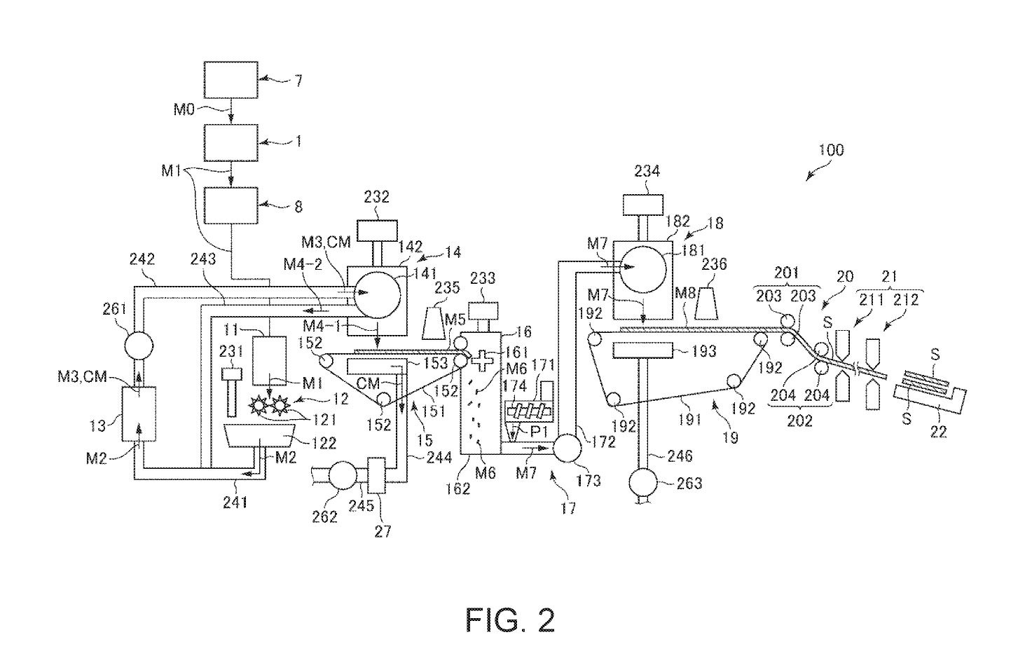

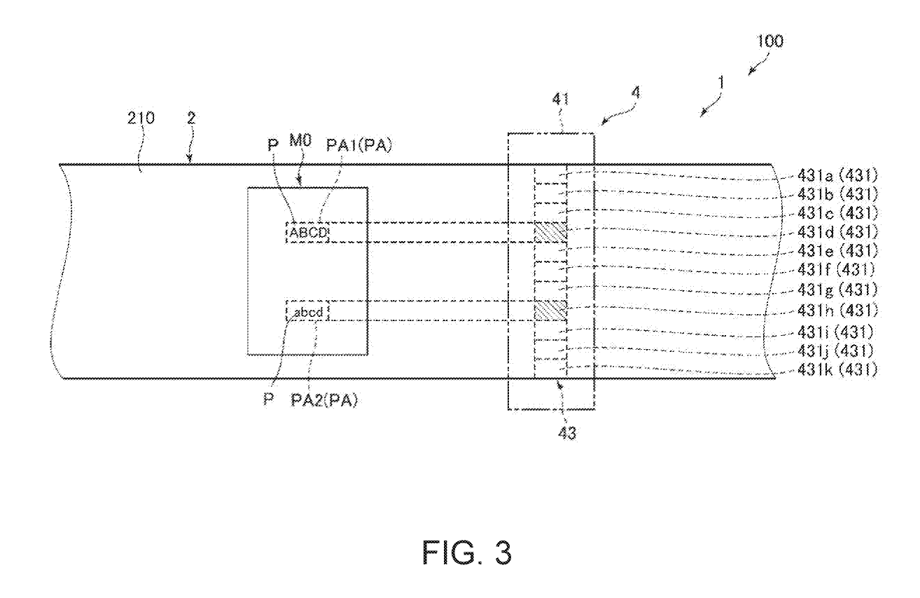

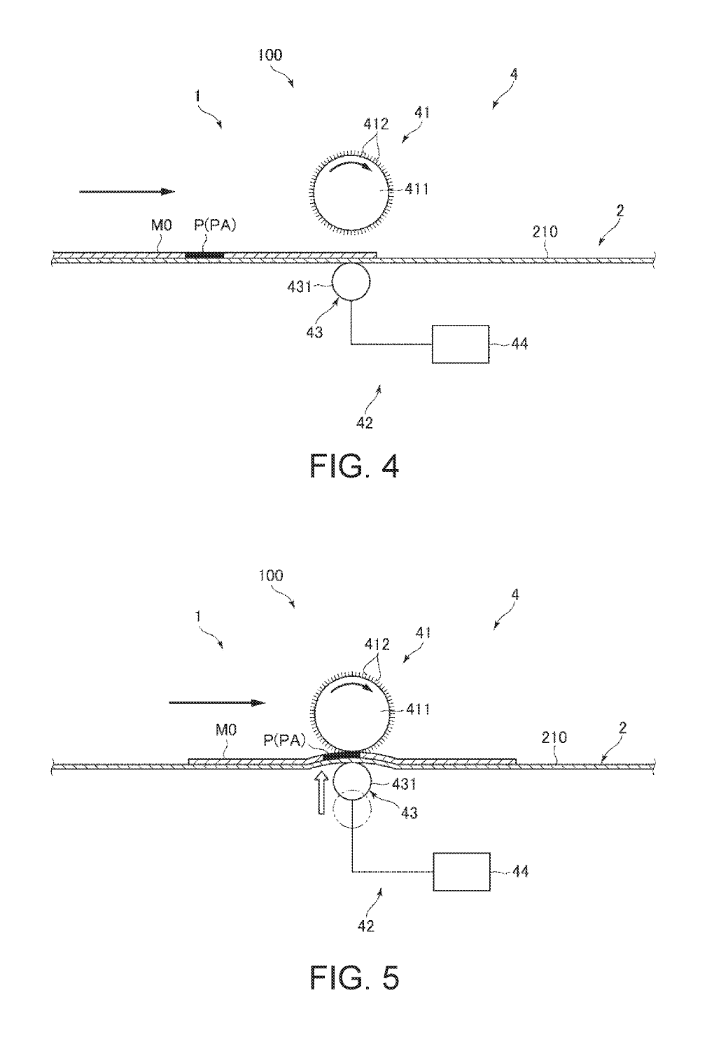

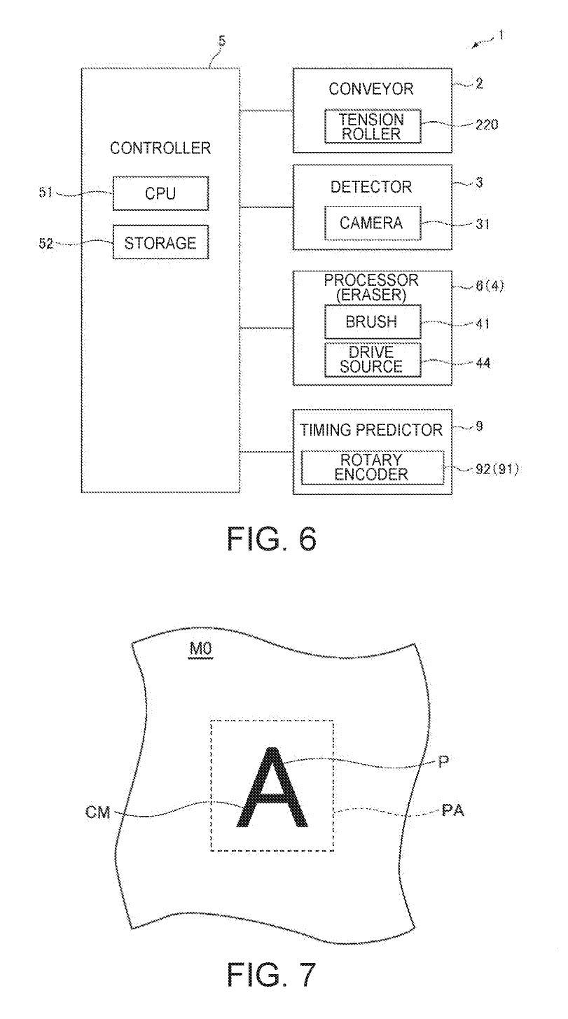

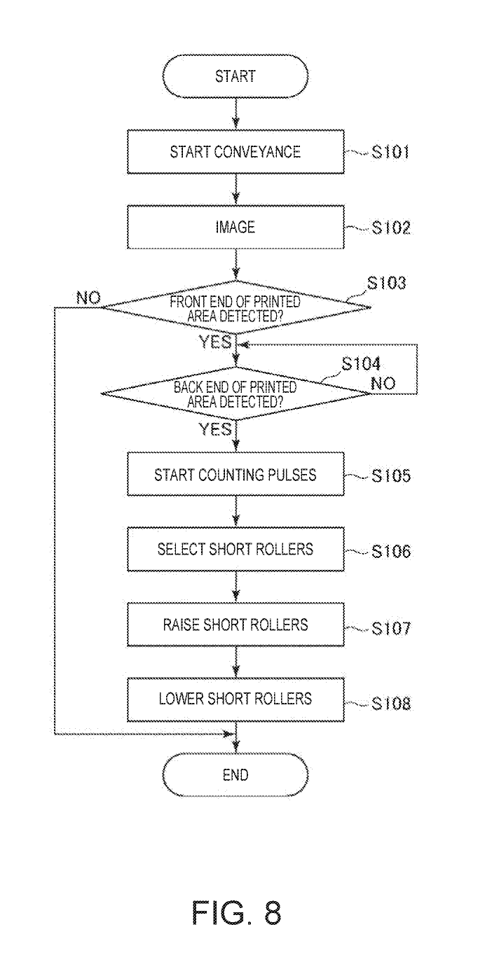

FIG. 1 is a schematic side view illustrating the configuration of a sheet processing device according to the invention disposed to the upstream side of a sheet manufacturing apparatus according to a first embodiment of the invention. FIG. 2 is a schematic side view illustrating the configuration of the downstream side of a sheet manufacturing apparatus according to the first embodiment of the invention. FIG. 3 is a top view of the sheet processing device shown in FIG. 1. FIG. 4 is a side view of the sheet processing device shown in FIG. 1. FIG. 5 is a side view of the sheet processing device shown in FIG. 1. FIG. 6 is a block diagram of the sheet processing device shown in FIG. 1. FIG. 7 is an enlarged plan view of feedstock that is processed by the sheet processing device shown in FIG. 1. FIG. 8 is a flow chart describing a control operation of the controller shown in FIG. 6.

Note that for convenience below, the top as seen in FIG. 1 and FIG. 2 is referred to as the top or above, the bottom as the bottom or below. In addition, in FIG. 1 to FIG. 5, the left side is referred to as the left or the upstream side; and the right side is referred to as the right or the downstream side.

The sheet processing device 1 according to the invention shown in FIG. 1 has a conveyor 2 that conveys feedstock M0, which in this example is used sheets having a printed area PA where the sheet was previously printed; a position detector 3 (referred to below as simply a detector) configured to detect the location of a specific part of the feedstock M0 (sheet) conveyed by the conveyor 2; a processor 6 configured to apply a specific process to at least the printed area PA; a timing predictor 9 configured to predict, based on the detection result from the detector 3 (position detector), the timing when the printed area PA will reach the processor 6; and a controller 5 configured to control operation of the processor 6 based on the prediction result from the timing predictor 9.

Due to such factors as deviation between parts in the sheet processing device 1 (such as the glue belt 210 and tension roller 220 of the conveyor 2), and change in the voltage applied to the motor that drives the tension roller 220, the actual conveyance speed of the feedstock M0 may be greater or less than the design value (rated speed) of the sheet processing device 1, and a difference may occur between the design value of the conveyance speed and the actual conveyance speed. As a result, the conveyance timing of feedstock M0 conveyance cannot be synchronized with the process timing when the process is applied to the printed area PA1 of the feedstock M0, and accurately processing the printed area PA1 without excess or deficiency may be difficult.

As described further below, the invention therefore starts counting the drive pulse count indicating the amount of rotation of the tension roller 220 after the front end FE1 of the printed area PA, for example, is detected by the detector 3. Once this pulse count reaches a specified pulse count, the front end FE1 of the printed area PA is presumed to have reached the processor 6, and processing by the processor 6 can start.

The invention also starts counting the number of pulses applied to the motor after the back end BE1 of the printed area PA is detected by the detector 3. Once this count reaches a specified pulse count, the back end BE1 of the printed area PA is presumed to have reached the processor 6, and processing by the processor 6 can be stopped.

This operation enables the sheet processing device 1 to synchronize the conveyance timing for conveying the feedstock MO with the process timing for processing the printed area PA1 of the feedstock M0. As a result, the process of the processor 6 can be accurately applied without excess or deficiency to at least the printed area PA of the feedstock M0 regardless of the conveyance state (such as change in the conveyance speed, and pauses in conveyance) of the feedstock M0.

As shown in FIG. 2, the sheet manufacturing apparatus 100 of the invention includes this sheet processing device 1, and makes new sheets S using the feedstock M0 (sheets) processed by the processor 6 as the source material (feedstock).

The invention thus comprised can therefore receive the benefits of the above sheet processing device 1 while making new sheets S (recycled paper) from the feedstock M0 processed by the processor 6.

The configuration of parts of the sheet manufacturing apparatus 100 is described next.

As shown in FIG. 1, the sheet manufacturing apparatus 100 has, on the upstream side, a first feedstock hopper 7, the sheet processing device 1 according to the invention, and a second feedstock hopper 8. As shown in FIG. 2, the sheet manufacturing apparatus 100 has, on the downstream side, a feedstock supply device 11, a shredder 12, a defibrator 13, a classifier 14, a first web forming device 15, a cutter 16, a mixing device 17, a detangler 18, a second web forming device 19, a sheet forming device 20, a paper cutter 21, and a stacker 22. The sheet manufacturing apparatus 100 thus comprised can recycle feedstock M0 to make new sheets S (recycled paper) of paper.

The sheet manufacturing apparatus 100 also has wetting unit 231, wetting unit 232, wetting unit 233, wetting unit 234, wetting unit 235, and wetting unit 236.

Operation of parts of the sheet manufacturing apparatus 100 is controlled by a controller 5, for example. The controller 5 may be incorporated into the sheet manufacturing apparatus 100, or it may be embodied by an external device such as an external computer. The external device may communicate with the sheet manufacturing apparatus 100 through a cable (wired connection), through a wireless connection, or be connected to the sheet manufacturing apparatus 100 through a network (such as the Internet).

As shown in FIG. 1, the first feedstock hopper 7 is the part where feedstock M0, that is, primary feedstock, which in this example is sheets (used sheets) to be processed by the sheet processing device 1, is stocked. The feedstock M0 in this example is fiber-containing material including fiber (particularly cellulosic fiber), and in this example is in a sheet form. In this embodiment, the feedstock M0 is recovered paper, that is, sheets that have been used, but the invention is not so limited and the feedstock M0 may be sheets that have not been used.

Note that the cellulose fiber may be any fibrous material containing mainly cellulose (narrowly defined cellulose) as a chemical compound, and in addition to cellulose (narrowly defined cellulose) may include hemicellulose or lignin.

The sheet processing device 1 according to the invention is disposed on the downstream side of the first feedstock hopper 7. The sheet processing device 1 applies the process described below to the feedstock M0, producing feedstock M1, secondary feedstock, that is stored in the second feedstock hopper 8. A feedstock supply device 11 is disposed on the downstream side of the second feedstock hopper 8.

The feedstock supply device 11 is the part that executes the feedstock supply process supplying feedstock M1 conveyed from the second feedstock hopper 8 to the shredder 12.

The shredder 12 is the part that executes the shredding process of shredding, in air, the feedstock M1 supplied from the feedstock supply device 11. The shredder 12 has a pair of shredder blades 121 and a chute (hopper) 122.

By turning in opposite directions of rotation, the pair of shredder blades 121 shred the feedstock M1 passing therebetween, that is, cut the feedstock M1 into small shreds M2. The size and shape of the shreds M2 are preferably appropriate to the defibration process of the defibrator 13, and in this example are preferably pieces 100 mm or less on a side, and are further preferably pieces that are greater than or equal to 10 mm and less than or equal to 70 mm per side.

The chute 122 is located below the pair of shredder blades 121, and in this example is funnel-shaped. As a result, the chute 122 can easily catch the shreds M2 that are shredded and dropped by the shredder blades 121.

Above the chute 122, a wetting unit 231 is disposed beside the pair of shredder blades 121. The wetting unit 231 wets the shreds M2 in the chute 122. This wetting unit 231 has a filter (not shown in the figure) containing water, and is configured as a heaterless humidifier (or heated humidifier) that supplies a moist stream of air to the shreds M2 by passing air through the filter. By wet air being supplied to the shreds M2, shreds M2 sticking to the chute 122 due to static electricity can be suppressed.

The chute 122 connects to the defibrator 13 through a conduit (flow channel) 241. The shreds M2 collected in the chute 122 passes through the conduit 241 and are conveyed to the defibrator 13.

The defibrator 13 is the part that executes the defibrating process (refining process) that defibrates the shreds M2 (fiber-containing material including fiber) in a dry process in air. Defibrated material M3 can be produced from the shreds M2 by the defibration process of the defibrator 13.

As used herein, defibrate means to break apart and detangle into single individual fibers shreds M2 composed of many fibers bonded together. The resulting detangled fibers are the defibrated material M3. The shape of the defibrated material M3 is strings and ribbons. The defibrated material M3 may also contain clumps, which are multiple fibers tangled together into clumps.

The defibrator 13 in this embodiment of the invention, for example, is configured as an impeller mill having a rotor that turns at high speed, and a liner disposed around the rotor. Shreds M2 introduced to the defibrator 13 are defibrated between the rotor and the liner.

The defibrator 13, by rotation of the rotor, produces an air flow (current) from the shredder 12 to the classifier 14. As a result, shreds M2 can be suctioned from the conduit 241 to the defibrator 13. In addition, after the defibration process, the defibrated material M3 can be fed through another conduit 242 to the classifier 14.

The defibrator 13 also functions to separate from the fibers materials such as resin particles bonded with the defibrated material M3 (shreds M2), ink, toner, and other color material CM, and bleeding inhibitors.

The defibrator 13 also connects through a conduit 242 (flow path) to the classifier 14. The defibrated material M3 (fiber-containing material after defibration) is conveyed through the conduit 242 to the classifier 14.

A blower 261 is disposed in the conduit 242. The blower 261 is an air flow generator that produces a flow of air to the classifier 14. This promotes conveyance of the defibrated material M3 to the classifier 14.

The classifier 14 executes a process of selecting defibrated material M3 based on the length of the fibers. The classifier 14 sorts the defibrated material M3 into first screenings M4-1, and second screenings M4-2 that are larger than the first screenings M4-1. The first screenings M4-1 are a size suitable to making sheets S. The second screenings M4-2 include insufficiently defibrated material, and excessively clumped defibrated fiber.

The classifier 14 includes a drum 141, and a housing 142 enclosing the drum 141.

The drum 141 is a sieve comprising a cylindrical mesh body that rotates on its center axis. The defibrated material M3 flows into the drum 141. As the drum 141 rotates, defibrated material M3 that is smaller than the mesh openings is selected as the first screenings M4-1, and defibrated material M3 that is larger than the mesh openings is selected as the second screenings M4-2.

The first screenings M4-1 drop out from the drum 141.

The second screens M4-2 are discharged to the conduit (flow path) 243 connected to the drum 141. The end of the conduit 243 on the opposite end (downstream end) as the drum 141 is connected to another conduit 241. The second screenings M4-2 passing through conduit 243 merge with the shreds M2 in conduit 241, and flow with the shreds M2 into the defibrator 13. As a result, the second screenings M4-2 are returned to the defibrator 13 and again defibrated with the shreds M2.

The first screenings M4-1 from the drum 141 are dispersed while dropping through air, and descend toward the first web forming device 15 (separator) below the drum 141. The first web forming device 15 is the part that executes a first web forming process forming a first web M5 from the first screenings M4-1.

The first web forming device 15 includes a mesh belt (separation belt) 151, three tension rollers 152, and a suction unit (suction mechanism) 153.

The mesh belt 151 is an endless belt (belt loop) on which the first screened material M4-1 accumulates. This mesh belt 151 is mounted on three tension rollers 152. By rotationally driving the tension rollers 152, the first screened material M4-1 deposited on the mesh belt 151 is conveyed downstream.

The size of the first screened material M4-1 is greater than or equal to the size of the mesh in the mesh belt 151. As a result, passage of the first screened material M4-1 through the mesh belt 151 is limited, and as a result the first screened material M4-1 accumulates on the mesh belt 151.

Furthermore, because the first screened material M4-1 is conveyed downstream by the mesh belt 151 as the first screened material M4-1 accumulates on the mesh belt 151, the first screened material M4-1 is formed in a layer as a first web M5.

Color material CM is removed from the feedstock M1 by the sheet processing device 1, but some color material CM not completely removed by the sheet processing device 1 may remain. Because the color material CM is smaller than the mesh openings of the mesh belt 151, the color material CM passes through the mesh belt 151 and precipitates. This enables removing remnants of color material CM not removed by the sheet processing device 1.

The suction unit 153 suctions air from below the mesh belt 151. As a result, color material CM that has past through the mesh belt 151 can be suctioned together with the air.

The suction unit 153 is connected to a dust collector (collection device) through another conduit (flow path) 244. Color material CM suctioned by the suction unit 153 are captured by the dust collector 27.

Another conduit (flow path) 245 is also connected to the dust collector 27. A blower 262 is disposed to the conduit 245. Operation of the blower 262 produces suction in the suction unit 153. This promotes formation of the first web M5 on the mesh belt 151. The first web M5 is made from material from which color material CM has been removed. Operation of the blower 262 causes the color material CM to pass through the conduit 244 and reach the dust collector 27.

The housing 142 is connected to a wetting unit 232. Like the wetting unit 231 described above, the wetting unit 232 is a heaterless humidifier. As a result, wet air is supplied into the housing 142. This wet air moistens the first screened material M4-1, and as a result can suppress sticking of the first screened material M4-1 to the inside walls of the housing 142 due to static electricity.

Another wetting unit 235 is disposed downstream from the classifier 14. This wetting unit 235 is configured as an ultrasonic humidifier that mists water. As a result, moisture can be supplied to (can humidify or moisten) the first web M5, and the moisture content of the first web M5 can thereby be adjusted. This adjustment can also suppress sticking of the first web M5 to the mesh belt 151 due to static electricity. As a result, the first web M5 easily separates from the mesh belt 151 at the tension roller 152 from where the mesh belt 151 returns to the upstream side.

On the downstream side of the wetting unit 235 is a cutter 16. The cutter 16 is a part that executes a cutting process of cutting the first web M5 that has separated from the mesh belt 151.

The cutter 16 has a propeller 161 that is rotationally supported, and a housing 162 that houses the propeller 161. The first web M5 is cut into pieces by the first web M5 being fed into the rotating propeller 161. The cut first web M5 forms segments M6. The segments M6 then drop down in the housing 162.

The housing 162 is connected to another wetting unit 233. Like the wetting unit 231 described above, the wetting unit 233 is a heaterless humidifier. As a result, wet air is supplied into the housing 162. This wet air suppresses sticking of the segments M6 to the propeller 161 and to the inside walls of the housing 162 due to static electricity.

A mixing device 17 is disposed on the downstream side of the cutter 16. The mixing device 17 is the part that executes a mixing process of mixing the segments M6 with resin P1. The mixing device 17 includes a resin supply device 171, a conduit (flow path) 172, and a blower 173.

The conduit 172 connects to the housing 162 of the cutter 16 and the housing 182 of the detangler 18, and is a flow path through which a mixture M7 of the segments M6 and resin P1 passes.

The resin supply device 171 connects to the conduit 172. The resin supply device 171 has a screw feeder 174. By rotationally driving the screw feeder 174, the resin P1 can be supplied in powder or particle form to the conduit 172. The resin P1 supplied to the conduit 172 is mixed with the segments M6, forming the mixture M7.

Note that the resin P1 bonds fibers together in a downstream process, and may be a thermoplastic resin or a thermosetting resin, but is preferably a thermoplastic resin. Examples of such thermoplastic resins include AS resin, ABS resin, polyethylene, polypropylene, ethylene-vinylacetate copolymer (EVA), or other polyolefin, denatured polyolefins, polymethylmethacrylate or other acrylic resin, polyvinyl chloride, polystyrene, polyethylene terephthalate, polybutylene terephthalate or other polyesters, nylon 6, nylon 46, nylon 66, nylon 610, nylon 612, nylon 11, nylon 12, nylon 6-12, nylon 6-66 or other polyimide (nylon), polyphenylene ether, polyacetal, polyether, polyphenylene oxide, polyether ether ketone, polycarbonate, polyphenylene sulfide, thermoplastic polyimide, polyether imide, aromatic polyester, or other liquid crystal polymer, styrenes, polyolefins, polyvinyl chlorides, polyurethanes, polyesters, polyimides, polybutadienes, transpolyisoprenes, fluoroelastomers, polyethylene chlorides and other thermoplastic elastomers, as well as combinations of one or two or more of the foregoing. Preferably, a polyester or resin containing a polyester is used as the thermoplastic resin.

Additives other than resin P1 may also be supplied from the resin supply device 171, including, for example, coloring agents for adding color to the fiber, anti-blocking agents for suppressing clumping of the fiber and clumping of the resin Pl, and flame retardants for making the fiber and manufactured sheets difficult to burn. Starch and other vegetable materials may also be used.

The blower 173 is disposed to the conduit 172 downstream from the resin supply device 171. The blower 173 is configured to produce an air current toward the detangler 18. This air current can also mix the segments M6 and resin P1 inside the conduit 172. As a result, the mixture M7 can be introduced to the detangler 18 as a uniform dispersion of the segments M6 and resin P1. The segments M6 in the mixture M7 are further detangled into smaller fibers while travelling through the conduit 172.

The detangler 18 is the part that executes the detangling process that detangles interlocked fibers in the mixture M7.

The detangler 18 includes a drum 181 and a housing 182 that houses the drum 181.

The drum 181 is a sieve comprising a cylindrical mesh body that rotates on its center axis. The mixture M7 is introduced to the drum 181. By the drum 181 rotating, fiber in the mixture M7 that is smaller than the mesh can pass through the drum 181. The mixture M7 is detangled in this process.

The mixture M7 that is detangled in the drum 181 is dispersed while dropping through air, and falls to the second web forming device 19 located below the drum 181. The second web forming device 19 is the part that executes the second web forming process forming a second web M8 from the mixture M7. The second web forming device 19 includes a mesh belt 191 (separation belt), tension rollers 192, and a suction unit 193 (suction mechanism).

The mesh belt 191 is an endless belt on which the mixture M7 accumulates. This mesh belt 191 is mounted on four tension rollers 192. By rotationally driving the tension rollers 192, the mixture M7 deposited on the mesh belt 191 is conveyed downstream.

Most of the mixture M7 on the mesh belt 191 is larger than the mesh in the mesh belt 191. As a result, the mixture M7 is suppressed from passing through the mesh belt 191, and therefore accumulates on the mesh belt 191. The mixture M7 is conveyed downstream by the mesh belt 191 as the mixture M7 accumulates on the mesh belt 191, and is formed in a layer as the second web M8.

The suction unit 193 suctions air down from below the mesh belt 191. As a result, the mixture M7 can be pulled onto the mesh belt 191, and accumulation of the mixture M7 on the mesh belt 191 is thereby promoted.

Another conduit 246 (flow path) is connected to the suction unit 193. A blower 263 is also disposed to the conduit 246. Operation of the blower 263 produces suction in the suction unit 193.

Another wetting unit 234 is connected to the housing 182. Like the wetting unit 231 described above, the wetting unit 234 is a heaterless humidifier. As a result, wet air is supplied into the housing 182. By humidifying the inside of the housing 182 by adding wet air, sticking of the mixture M7 to the inside walls of the housing 182 due to static electricity can be suppressed.

Another wetting unit 236 is disposed below the detangler 18. This wetting unit 236 is configured as an ultrasonic humidifier similarly to the wetting unit 235 described above. As a result, moisture can be supplied to the second web M8, and the moisture content of the second web M8 can thereby be adjusted. This adjustment can also suppress sticking of the second web M8 to the mesh belt 191 due to static electricity. As a result, the second web M8 easily separates from the mesh belt 191 at the tension roller 192 from where the mesh belt 191 returns to the upstream side.

A sheet forming device 20 is disposed downstream from the second web forming device 19. The sheet forming device 20 is the part that executes the sheet forming process forming sheets S from the second web M8. This sheet forming device 20 includes a calender 201 and a heater 202.

The calender 201 comprises a pair of calender rolls 203, and compresses the second web M8 between the calender rolls 203 without heating the second web M8. This process increases the density of the second web M8. The second web M8 is then conveyed toward the heater 202. Note that one of the pair of calender rolls 203 is a drive roller that is driven by operation of a motor (not shown in the figure), and the other is a driven roller.

The heater 202 has a pair of heat rollers 204, which can heat while compressing the second web M8 between the heat rollers 204. The combination of heat and pressure melts the resin P1 in the second web M8, and binds fibers through the molten resin Pl. As a result, a sheet S is formed.

The sheet S is then conveyed to the paper cutter 21. Note that one of the pair of heat rollers 204 is a drive roller that is driven by operation of a motor (not shown in the figure), and the other is a driven roller.

A paper cutter 21 is disposed downstream from the sheet forming device 20. The paper cutter 21 is the part that executes the sheet cutting process that cuts the continuous sheet S into single sheets S. The paper cutter 21 includes a first cutter 211 and a second cutter 212.

The first cutter 211 cuts the sheet S in the direction crosswise to the conveyance direction of the sheet S.

The second cutter 212 is downstream from the first cutter 211, and cuts the sheets S in the direction parallel to the conveyance direction of the sheet S.

Sheets S of a desired size are produced by the cutting action of the first cutter 211 and the second cutter 212. The sheets S are then conveyed further downstream and stacked in a stacker 22.

A sheet processing device 1 according to the invention is described next.

The sheet processing device 1 shown in FIG. 1 is disposed on the upstream side of the sheet manufacturing apparatus 100, and in this example is a device that applies, to the printed area PA of the feedstock M0 described above, a process that removes color material CM in the printed part P of the printed area PA.

This sheet processing device 1 includes a conveyor 2, detector 3, and, as an example of a processor 6, an eraser 4 (color eraser), configured as a unit inside a housing not shown.

Note that, as shown in FIG. 2, the sheet processing device 1 is preferably disposed or connects to the feedstock supply device 11 through the second feedstock hopper 8. This enables executing the sheet process and sheet remanufacturing process in a single continuous operation.

Note that in this example the feedstock M0 is recovered paper, that is, used sheets that were previously printed on. As a result, the feedstock M0 may be printed with text and graphics formed by application of color material CM such as black or color toners, inks, dyes, pigments, or other materials to the feedstock M0.

Herein, that part of the feedstock M0 to which such color material CM is applied is referred to as the printed part P. The printed part P is not limited to text, and may include symbols, graphics, and even simply areas of smudging or soiling, for example.

As shown in FIG. 7, the printed area PA refers to that part of the feedstock M0 containing at least printed part P and some amount of surrounding white space (margin), and may be rectangular, square, round, oval, or any other shape, but in this example is described as rectangular. Note also that the printed area PA does not necessarily include white space (a margin). Furthermore, if the printed part P comprises text arranged in lines (rows or columns), the printed area PA may be an area containing those lines (rows or columns). The printed area PA is defined by the controller 5 described below.

Parts of the sheet processing device 1 are described next.

The conveyor 2 conveys downstream preprocessed feedstock M0 supplied from the first feedstock hopper 7. The conveyor 2 includes a glue belt 210 (endless belt) used as a conveyor belt, and four rotationally supported tension rollers (rollers) 220. The glue belt 210 is mounted around the tension rollers 220. At least one of the tension rollers 220 has an internal motor, which drives and turns in the direction of the arrow in FIG. 1 when energized. As a result, the feedstock M0 on the glue belt 210 can be conveyed downstream.

As shown in FIG. 6, the tension roller 220, which drives when the motor is energized, is electrically connected to the controller 5, and tension roller 220 operation is controlled by the controller 5. As a result, the conveyance speed of the feedstock M0 can be changed in steps or continuously.

The surface of the glue belt 210 is preferably adhesive. This enables stably conveying the feedstock M0, and consistently detecting the printed area PA and processing the printed area PA. When processing the printed area PA involves grinding the printed area PA, tension is applied to the feedstock M0 while grinding and the position of the printed area PA may shift, but using an adhesive glue belt 210 can prevent the feedstock M0 from shifting position. The timing of the grinding step becoming offset from the location of the printed area PA as a result of the shifted position of the feedstock M0 can therefore be prevented.

Note that the same effect can be achieved when the glue belt 210 does not have an adhesive surface by providing a suction mechanism that pulls the feedstock M0 to the glue belt 210 by suction through the glue belt 210.

Multiple sheets of feedstock M0 can also be carried on the glue belt 210 at one time. The orientation (positioning) of each sheet of feedstock M0 on the glue belt 210 may also be aligned (the same) or not.

In this example the feedstock M0 is rectangular and is placed on the glue belt 210 so that the front end FE (one side) at the leading end of the feedstock M0 in the conveyance direction, and the back end BE (one side) at the trailing end of the feedstock M0 in the conveyance direction, are perpendicular to the conveyance direction.

Note that the conveyor 2 configuration shown in FIG. 1 is a belt conveyor, but the invention is not so limited and may be a configuration that conveys while holding the feedstock M0 by negative pressure suction on a stage, that is, a configuration that has a platen and conveys by means of multiple rollers.

The detector 3 detects the location of a specific part of the feedstock M0 conveyed by the conveyor 2. In this embodiment, this specific part in this embodiment is the printed area PA. The detector 3 (position detector) has a camera 31 such as a CCD camera as the imaging device for imaging at least the printed part P of the feedstock M0 (sheet). The camera 31 is disposed separated from one side of the glue belt 210, that is, above the top side of the glue belt 210 in this example. The printed area PA can be accurately detected by acquiring a gray scale image of the printed area PA with the camera 31, and digitally processing the gray scale image.

As shown in FIG. 6, the camera 31 is electrically connected to the controller 5, and its operation is controlled by the controller 5. Image data captured by the camera 31 is sent to the controller 5.

Note that the detector 3 is a camera 31 that captures a two-dimensional image in the configuration according to this embodiment, but the invention is not so limited, and may be a sensor or scanner that acquires a one-dimensional line image, for example. In this case, the detector 3 may be a reflective or transmissive detector.

The processor 6 is located downstream from the detector 3. The processor 6 is a part that executes a specific process on at least the printed area PA. In this embodiment, the processor 6 has an eraser 4 that selectively removes at least the surface part of the printed area PA.

The eraser 4 includes a brush 41, which is a grinding tool (grinder) for grinding the feedstock M0 (sheet), and a pressure mechanism 42 for selectively increasing the contact pressure between the feedstock M0 (sheet) and the brush 41 (grinder) in the printed area PA. This configuration enables selectively removing the printed area PA of the feedstock M0 as described further below.

The brush 41 includes a core 411 and bristles 412.

The core 411 is connected to a motor (not shown in the figure), and the bristles 412 turn in the direction of the arrow when the motor is driven. The axis of rotation of the brush 41 is disposed substantially perpendicular to the conveyance direction of the feedstock M1. However, the invention is not so limited, and the axis of rotation may be disposed inclined a specific angle (such as greater than or equal to 5 degrees and less than or equal to 45 degrees) to the direction perpendicular to the axis of rotation.

Bristles 412 are implanted to the entire outside surface of the core 411. The bristles 412 are made from a pliable resin material such as polyimide or polyester. The tips of the bristles 412 may be sharp or rounded.

When the brush 41 turns in the direction of the arrow in the figure while in contact with the sheet S, the sheet S is abraded (ground). Note that the brush 41 may be configured to turn in the opposite direction as shown in the figure, or to periodically alternate between clockwise and counterclockwise rotation. The brush 41 may also be configured to move (bidirectionally) in the same direction as the direction of rotation as the brush 41 turns.

This embodiment describes using a brush 41 as the grinder for abrading the feedstock M0, but the invention is not so limited, and the grinder may be a whetstone or file, for example.

The pressure mechanism 42 includes a roller group 43 as pressure members, and a drive source 44 that independently operates the individual short rollers 431 (pressure members) of the roller group 43.

As shown in FIG. 3, the roller group 43 is disposed to a position opposite the brush 41 with the glue belt 210 therebetween, and its position in the conveyance direction of the feedstock M0 is the same as the brush 41. The roller group 43 includes multiple (11 in the configuration shown in the figure) short rollers 431.

The short rollers 431 have a cylindrical outside shape, and are disposed with the axis of rotation substantially perpendicular to the conveyance direction of the feedstock M1. The short rollers 431 are disposed substantially coaxially in a line across the width of the glue belt 210.

Each of the short rollers 431 are configured movably to and away from the brush 41. The short rollers 431 intermittently apply pressure through the glue belt 210 to the opposite side of the feedstock M0 as the brush 41 (the bottom side as seen in FIG. 1, FIG. 4, and FIG. 5).

The pressure mechanism 42 thus has a roller group 43 that is disposed movably to and away from the brush 41, and directly or indirectly (indirectly in this embodiment) applies pressure to the feedstock M0 from the opposite side of the feedstock M0 as the brush 41. As a result, the printed area PA of the feedstock M0 can be pushed against the brush 41 and ground.

The sheet processing device 1 also has a conveyor 2 that conveys the feedstock M0 at least between the detector 3 and eraser 4 by means of a glue belt 210, and the roller group 43 pushes the feedstock M0 through the glue belt 210 against the brush 41. The roller group 43 applying excessive pressure to the feedstock M0 can therefore be prevented. As a result, unintentionally damaging the feedstock M0 can be prevented.

The plural short rollers 431 are disposed across the width of the glue belt 210, that is, in a direction intersecting the conveyance direction of the feedstock M0 in the eraser 4. As a result, as described below, pressure can be applied to the printed area PA regardless of where on the feedstock M0 the printed area PA is located. This means that the printed area PA can be removed by pushing the brush 41 against the printed area PA regardless of where on the feedstock M0 the printed area PA is located.

Furthermore, the size of the roller group 43 can be reduced and a relatively large number of short rollers 431 can be provided by using rollers or pins as the short rollers 431. As a result, even relatively small printed areas PA can be ground and removed with good precision.

The short rollers 431 may be configured to rotate or not rotate.

The drive source 44 can move the short rollers 431 independently up and down, that is, to and away from the brush 41. Insofar as this ability is provided, the configuration of the drive source 44 is not specifically limited, and the drive source 44 may be configured with multiple drive elements such as air cylinders or solenoids connected to the individual short rollers 431. The drive source 44 in this configuration is electrically connected to the controller 5 and operation is controlled by energizing the drive elements.

As shown in FIG. 4, until the feedstock M0 is conveyed to the eraser 4 in the sheet processing device 1, the glue belt 210 and brush 41 are separated. When an area outside the printed area PA of the feedstock M0 (that is, white space) passes between the brush 41 and short rollers 431, the short rollers 431 do not operate.

As shown in FIG. 5, timed to when the printed area PA of the feedstock M0 passes between the brush 41 and short rollers 431, one or more short rollers 431 move toward the brush 41, and push the glue belt 210 and feedstock M1 up, causing the printed area PA of the feedstock M1 to contact the brush 41.

As a result, contact pressure between brush 41 and the printed area PA of the feedstock M0 increases, the surface part of the printed area PA is abraded. As a result, the printed part P, that is, the color material CM, is removed from the feedstock MO without excess or deficiency. Specifically, because grinding of areas outside the printed area PA is prevented, the amount of fiber supplied as feedstock M1 to the downstream sheet manufacturing apparatus 100 can be increased as much as possible. Yield is therefore good and sheets S with a high degree of whiteness can be produced.

Note that the surface part as referred to herein means the portion to a depth of 1/10 to ½ of the thickness from the surface. While the whiteness of the manufactured sheets S can be improved by removing at least the surface part of the printed area PA, grinding to a greater depth from the surface part is preferable when the color material CM has penetrated to a greater depth or the color material CM is relatively dark. Depending on the degree of penetration of the color material CM and the color of the color material CM, the feedstock M1 may be ground until through-holes are formed. The depth of color material CM penetration can be estimated from the type of color material CM, the type of fiber in the feedstock M0, the density, and other factors. If this information is already known, the contact pressure of the short rollers 431 and brush 41 against the feedstock M0 is desirably adjusted.

In the example in FIG. 3, when there are two printed parts P on the feedstock M0 and two printed areas PA are defined, the printed areas PA are removed as described below. These two printed areas PA are identified from the top in FIG. 3 as printed area PA1 and printed area PA2. The eleven short rollers 431 are identified from the top in FIG. 3 as short roller 431a, short roller 431b, short roller 431c, short roller 431d, short roller 431e, short roller 431f, short roller 431g, short roller 431h, short roller 431i, short roller 431j, short roller 431k.

In the sheet processing device 1 in the example in FIG. 3, short roller 431d corresponding to printed area PA1, that is, at the same position in the direction perpendicular to the glue belt 210, and short roller 431h corresponding to printed area PA2, that is, at the same position in the direction perpendicular to the glue belt 210, operate, and the other short rollers 431 do not operate. More specifically, only short roller 431d and short roller 431h located at the positions capable of grinding printed area PA1 and printed area PA2 push the feedstock M0 against the brush 41.

The roller group 43 thus has multiple short rollers 431, and selectively drives the short rollers 431 to increase the contact pressure of the brush 41 on specific parts of the feedstock M0. Grinding the feedstock M0 outside the printed area PA can therefore be more reliably prevented, and the amount of fiber supplied as feedstock M1 to the sheet manufacturing apparatus 100 downstream can be further increased. Sheets S can therefore be manufactured with good yield.

The glue belt 210 and brush 41 are separated until the feedstock M0 is conveyed to the eraser 4 in this configuration, but the invention is not so limited and the glue belt 210 and brush 41 may be in contact.

The brush 41 in this embodiment is configured to rotate even when not grinding the feedstock M0, but the invention is not so limited, and may be configured to turn only when grinding the feedstock M0, that is, so the short rollers 431 turn only when the feedstock M0 is pushed up.

Note also that the eraser 4 in this example is configuration to abrade and remove the printed area PA, but the invention is not so limited, and the eraser 4 may be configured to stamp through the printed area PA.

As shown in FIG. 6, the controller 5 includes a CPU 51 (processor) and storage 52 (memory, hard disk drive, for example), and controls operation of the conveyor 2, detector 3, and processor 6 (eraser 4).

The CPU 51 executes programs stored in storage 52. The CPU 51 functions as a data processor that processes image data captured by the camera 31.

The storage 52 in this example is rewritable nonvolatile memory. Programs such as programs related to sheet processing as described above are stored in storage 52, and the programs are run by the CPU 51.

As described above, the detector 3 has a camera 31 (imaging device) that images the feedstock M0 (sheet). The controller 5 has a CPU 51 that functions as a data processor that processes image data captured by the camera 31 (imaging device). This enables identifying the printed part P and defining the printed area PA.

Depending on such factors as individual differences between parts of the sheet processing device 1 (such as the glue belt 210 and tension roller 220), and change in the voltage applied to the motor that drives the tension roller 220, the conveyance speed of the feedstock M0 in the sheet processing device 1 may be greater or less than the design speed, resulting in a difference between the design value of the conveyance speed and the actual conveyance speed. When this happens, the timing of feedstock M0 conveyance cannot be synchronized with the process timing, that is, the timing when the printed area PA1 of the feedstock M0 is processed. As a result, accurately processing the printed area PA1 without excess or deficiency becomes difficult.

The sheet processing device (sheet manufacturing apparatus 100) according to the invention is configured to solve this problem. The configuration and operation of the sheet processing device (sheet manufacturing apparatus 100) is described below.

As shown in FIG. 1, the sheet processing device 1 has a timing predictor 9 that predicts, based on the detection result from the detector 3, the timing (time) when the printed area PA will reach the eraser 4.

As described above, the conveyor 2 has rotatably supported tension rollers 220 (rollers), and a glue belt 210 (endless belt) that is mounted around the tension rollers 220 (rollers) and on which the feedstock M0 (sheets) is placed.

The timing predictor 9 has an encoder 91 configured to detect the amount of rotation of the tension roller 220 (roller), or the amount of movement of the glue belt 210 (endless belt) accompanying rotation of the tension roller 220 (roller). The type of encoder 91 is not specifically limited, and in this embodiment is a rotary encoder 92 configured to optically or magnetically detect the amount of rotation of the tension roller 220.

The rotary encoder 92 in this example is inside (disposed to) one of the four tension rollers 220. The rotary encoder 92 is preferably disposed to the tension roller 220 at the front end in the conveyance direction of the feedstock M0 as shown in FIG. 1, but the invention is not so limited and the rotary encoder 92 may be disposed to one of the other tension rollers 220.

In this embodiment, the distance J in the conveyance direction of the feedstock M0 (the left-right direction in FIG. 1) from the center of the lens of the camera 31 (reference imaging position) to the axis of short roller 431 rotation is known, and is previously stored in the storage 52.

The number of rotations of the tension roller 220 housing the rotary encoder 92 required for the feedstock M0 to move distance J, that is, the rated pulse count (output pulse count) of the rotary encoder 92 equal to distance J, is also known, and is stored in storage 52.

The controller 5 can control operation of the eraser 4 (see FIG. 6) based on the prediction result from the timing predictor 9, that is, the amount of rotation of the tension roller 220 detected by the rotary encoder 92.

The configuration described above can start counting the amount of rotation of the tension roller 220, that is, the pulse count, after the front end FE1 of the printed area PA is detected by the camera 31. Once this count (referred to below as the first count) reaches the rated pulse count, the front end FE1 of the printed area PA is determined to have reached the eraser 4, and processing by the eraser 4 can start.

When the back end BE1 of the printed area PA is detected by the camera 31, measuring the amount of rotation of the tension roller 220, that is, counting the pulse count, starts. Once this count (referred to below as the second count) reaches the rated pulse count, the back end BE1 of the printed area PA is determined to have reached the eraser 4, and processing by the eraser 4 can end.

The sheet processing device 1 can therefore synchronize the conveyance timing of feedstock M0 conveyance with the process timing for processing the printed area PA1 of the feedstock M0. As a result, regardless of the conveyance state (such as change in the conveyance speed and pauses in conveyance) of the feedstock M0, processing by the eraser 4 can be accurately applied without excess or deficiency to the printed area PA of the feedstock M0.

The control operation of the controller 5 of the sheet processing device 1 is described next with reference to the flow chart in FIG. 8.

First, the conveyor 2 is operated to convey the feedstock M0 (step S101).

Next, the feedstock M0 on the glue belt 210 is imaged by the camera 31 (step S102). Note that the timing of imaging by the camera 31 is preferably adjusted according to the conveyance speed of the conveyor 2.

Next, front end FE1 of the printed area PA is detected from the image is acquired in step S102 (step S103). In this example in step S103, the image is divided into areas of a desirable size and digitized, areas in which the image density (brightness) is less than or equal to a specific level are determined to contain color material CM, and areas in which the image density (brightness) is greater than a specific level are determined to not contain color material CM. The front end FE1 of the printed area PA can be determined based on this information.

The back end BE1 of the printed area PA is then also detected by the same method applied in step S103 from the image acquired in step S102 (step S104).

Counting the number of pulses until the front end FE1 and the back end BE1 of the printed area PA respectively reach the eraser 4 then starts (step S105).

Next, which of the short rollers 431 in the roller group 43 to use this time are selected (step S106). Note that this selection is based on such information as the number, locations, and sizes of the printed areas PA in the image.

When the first count reaches the rated pulse count, the front end FE1 of the printed area PA is determined to have reached the eraser 4, the short rollers 431 selected in step S106 are driven up (raised), and the printed area PA is selectively removed (step S107).

Next, when the second count reaches the rated pulse count, the back end BE1 of the printed area PA is determined to have reached the eraser 4, the short rollers 431 selected in step S106 are driven down (lowered), and the printed area PA removal process ends (step S108).

Note that if the front end FE1 of the printed area PA is not detected in step S103, step S104-step S108 are skipped and conveyance of the feedstock M0 continues.

This control operation of the controller 5 enables executing a process of removing printed areas PA from parts of the feedstock M0.

### Embodiment 2

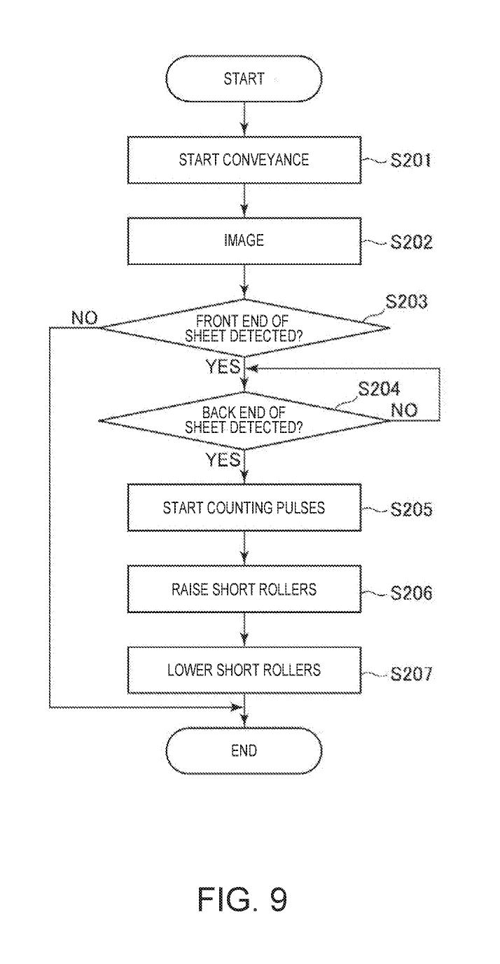

FIG. 9 is a flow chart describing the control operation of the controller in a sheet processing device according to a second embodiment of the invention.

A second embodiment of a sheet processing device and a sheet manufacturing apparatus according to the invention is described below with reference to the accompanying figures, focusing on the differences between this and the foregoing embodiment, and omitting or simplifying further description of like elements.

This embodiment is the same as the first embodiment described above except for the control operation of the controller.

As described above, the detector 3 is a device that detects the location of a specific part of the feedstock M0 conveyed by the conveyor 2. This specific part in this embodiment of the invention is the front end FE at the leading end of the feedstock M0 (sheet) in the conveyance direction, and the back end BE at the trailing end of the feedstock M0 (sheet) in the conveyance direction. The detector 3 (position detector) has a camera 31 (imaging device) configured to image at least the front end FE and the back end BE of the feedstock M0 (sheet). As a result, as described below, the removal process can be applied to the printed area PA, and an area beyond the printed area PA, such as the entire area (entire surface) on the front side of the feedstock M0.

The control operation of the controller 5 in this configuration is described below. This control operation is described based on the flow chart shown in FIG. 9.

First, the conveyor 2 is operated to convey the feedstock M0 (step S201).

Next, the feedstock M0 on the glue belt 210 is imaged by the camera 31 (step S202).

Next, front end FE of the feedstock M0 is detected from the image is acquired in step S102 (step S203).

The back end BE of the feedstock M0 is then also detected by the same method applied in step S203 from the image acquired in step S202 (step S204).

Next, counting the number of pulses until the front end FE and the back end BE of the feedstock M0 respectively reach the eraser 4 then starts as in the first embodiment (step S205).

When the pulse count at which the front end FE of the feedstock M0 reaches the eraser 4 equals the rated pulse count, the front end FE of the feedstock M0 is determined to have reached the eraser 4, and all short rollers 431 are driven up (raised) to start applying the removal process to the feedstock MO (step S206).

When the pulse count at which the back end BE of the feedstock M0 reaches the eraser 4 equals the rated pulse count, the back end BE of the feedstock M0 is determined to have reached the eraser 4, and all short rollers 431 are driven down (lowered) to stop applying the removal process to the feedstock MO (step S207).

Note that if the front end FE of the feedstock M0 is not detected in step S203, step S204-step S207 are skipped and conveyance continues.

This control operation of the controller 5 enables applying a removal process to the entire area (entire surface) of one side of the feedstock M0.

### Embodiment 3

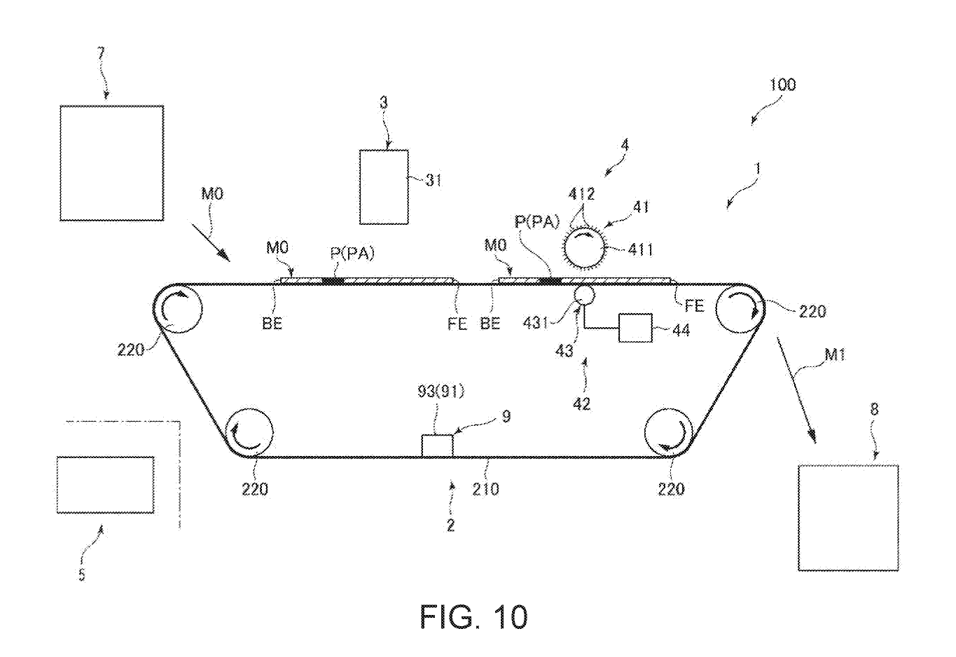

FIG. 10 is a schematic side view showing the configuration of a sheet manufacturing apparatus according to a third embodiment of the invention.

A third embodiment of a sheet processing device and a sheet manufacturing apparatus according to the invention is described below with reference to the accompanying figures, focusing on the differences between this and the foregoing embodiments, and omitting or simplifying further description of like elements.

This embodiment is the same as the first embodiment except for the configuration of the timing predictor.

As described above, the conveyor 2 has rotatably supported tension rollers 220 (rollers), and a glue belt 210 (endless belt) that is mounted around the tension rollers 220 (rollers) and on which the feedstock M0 (sheets) is placed.

The timing predictor 9 has an encoder 91 configured to detect the amount of rotation of the tension roller 220 (roller), or the amount of movement of the glue belt 210 (endless belt) accompanying rotation of the tension roller 220 (roller). The type of encoder 91 is not specifically limited, and in this embodiment is a linear encoder 93 configured to optically or magnetically detect the amount of movement of the glue belt 210. In the configuration shown in FIG. 10, the linear encoder 93 is disposed between the lower two tension rollers 220 of the four tension rollers 220, but the invention is not so limited.

This configuration is effective when using a linear encoder 93 as the encoder 91 is preferable.

### Embodiment 4

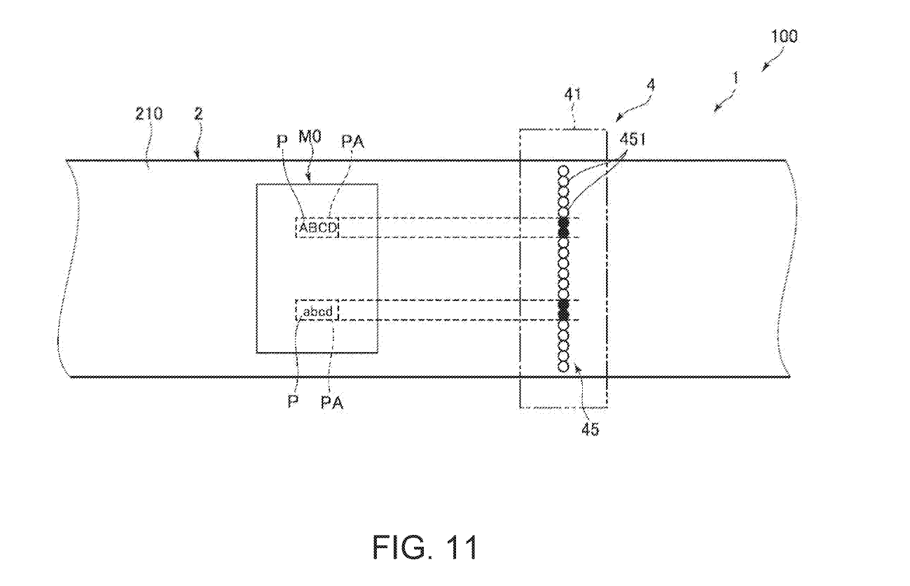

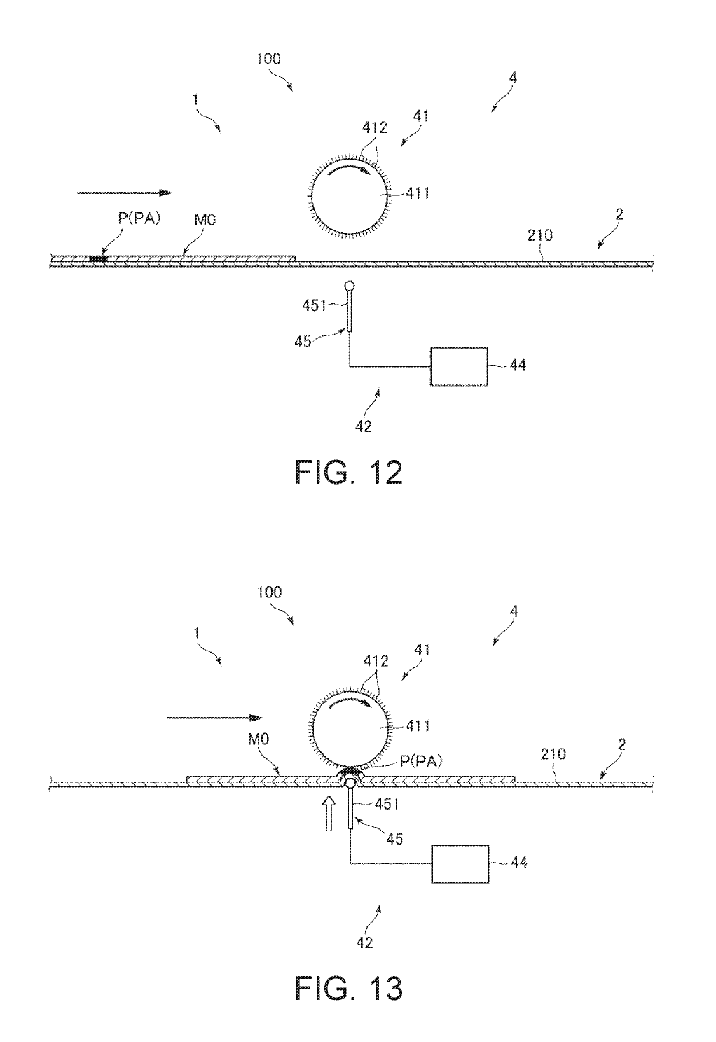

FIG. 11 is a top view illustrating the configuration of a sheet processing device according to a fourth embodiment of the invention. FIG. 12 is a schematic side view of the sheet processing device shown in FIG. 11. FIG. 13 is a schematic side view of the sheet processing device shown in FIG. 11.

A fourth embodiment of a sheet processing device and a sheet manufacturing apparatus according to the invention is described below with reference to the accompanying figures, focusing on the differences between this and the foregoing embodiments, and omitting or simplifying further description of like elements.

This embodiment is the same as the first embodiment except for the configuration of the pressure member of the eraser.

As shown in FIG. 11, the eraser 4 has a dot impact head 45 as a pressure member. The dot impact head 45 is disposed to a position opposite the brush 41 with the glue belt 210 therebetween, and its position in the conveyance direction of the feedstock M0 is the same as the brush 41.

The dot impact head 45 has multiple (17 in this example) pressure pins (pins) 451 disposed across the width of the glue belt 210, that is, in a direction intersecting (perpendicular to) the conveyance direction of the feedstock M0.

As shown in FIG. 12 and FIG. 13, the pressure pins 451 are disposed substantially perpendicularly to the thickness of the glue belt 210 (the thickness of the feedstock M0 being conveyed). The pressure pins 451 are connected to the drive source 44, and configured to move to and away from the brush 41 by driving the drive source 44.

The distal ends of the pressure pins 451, that is, the ends on the glue belt 210 side, are rounded. As a result, damage to the glue belt 210 when the pressure pins 451 push the glue belt 210 can be prevented.

As shown in FIG. 12, when an area outside the printed area PA of the feedstock M0 (that is, white space) passes between the brush 41 and pressure pins 451, the pressure pins 451 do not operate. Timed to when the printed area PA of the feedstock M0 passes between the brush 41 and pressure pins 451 as shown in FIG. 13, selected pressure pins 451 move toward the brush 41 and push the glue belt 210 and feedstock M1 up, causing the printed area PA to contact the brush 41. Note that in this embodiment only the pressure pins 451 of the dot impact head 45 aligned with the printed area PA, that is, the pressure pins 451 indicated by the black dots in FIG. 11, operate.

As a result, contact pressure between the brush 41 and the printed area PA of the feedstock M0 increases, the surface part of the printed area PA is abraded, and the printed part P of the feedstock M0, that is, the color material CM, is removed.

Because the pressure pins 451 are relatively small, even relatively small printed areas PA can be precisely removed. For example, the printed area PA can be limited to just the printed part P. In this case, the controller 5 preferably inverts the shape of the printed part P, divides this inverted shape into specific areas, and drives only those pressure pins 451 corresponding to the specific areas.

Note that the number of rows of pressure pins 451 in this embodiment is one, but the invention is not so limited and there may be two or more rows.

### Embodiment 5

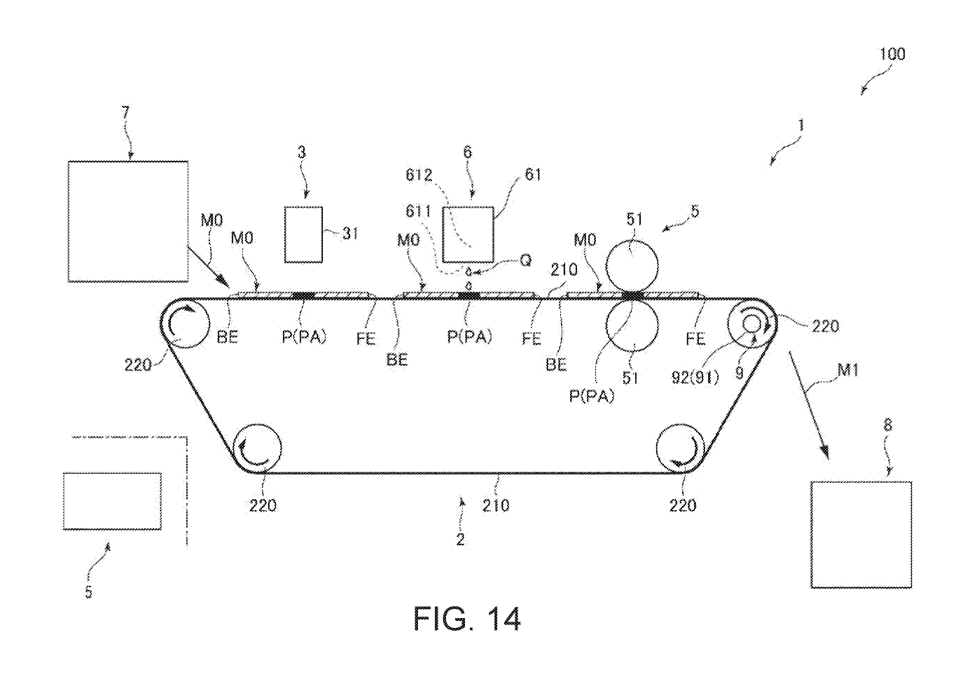

FIG. 14 is a schematic side view illustrating the configuration of a sheet processing device according to a fifth embodiment of the invention.

A fifth embodiment of a sheet processing device and a sheet manufacturing apparatus according to the invention is described below with reference to the accompanying figures, focusing on the differences between this and the foregoing embodiments, and omitting or simplifying further description of like elements.

This embodiment is the same as the first embodiment except for the configuration of the processor.

As shown in FIG. 14, the processor 6 in this embodiment has a color material applicator 61 configured to selectively apply ink Q of the same color as the color (background color) of the feedstock M0 to the printed area PA. For example, if the color of the feedstock M0 is white, the ink Q is preferably white. The color material applicator 61 can apply ink Q so that the ink Q completely penetrates the printed area PA, coloring the color material CM in the printed area PA with the color of the ink Q, and producing a white sheet S.

The color material applicator 61 (processor 6) has at least one nozzle 611 and a laminated piezo actuator 612, and is configured to apply ink Q using an inkjet drive method. As a result, ink Q can be ejected from the nozzle 611 and applied to the printed area PA at high speed to completely permeate the printed area PA.

Note that operation of the color material applicator 61 can be controlled based on the prediction result from the timing predictor 9 in this embodiment. As a result, ink Q can be applied by the color material applicator 61 to the printed area PA without excess or deficiency.

Note that applying ink Q to the feedstock M0 is not limited to the printed area PA, and ink Q may also be applied to parts outside the printed area PA (such as the entire area (entire surface) of one side of the feedstock M0).

### Embodiment 6

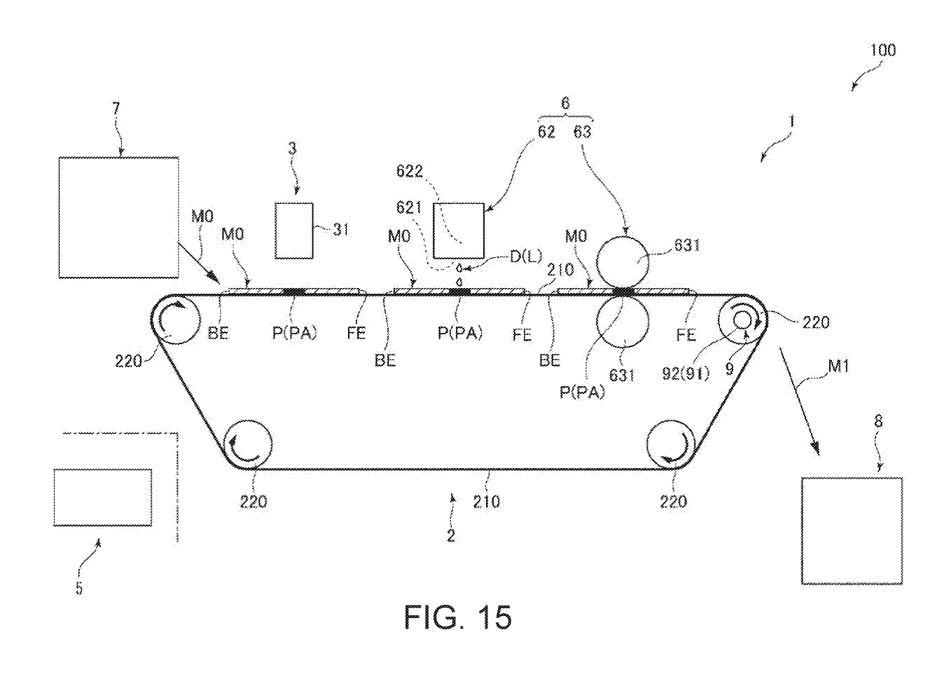

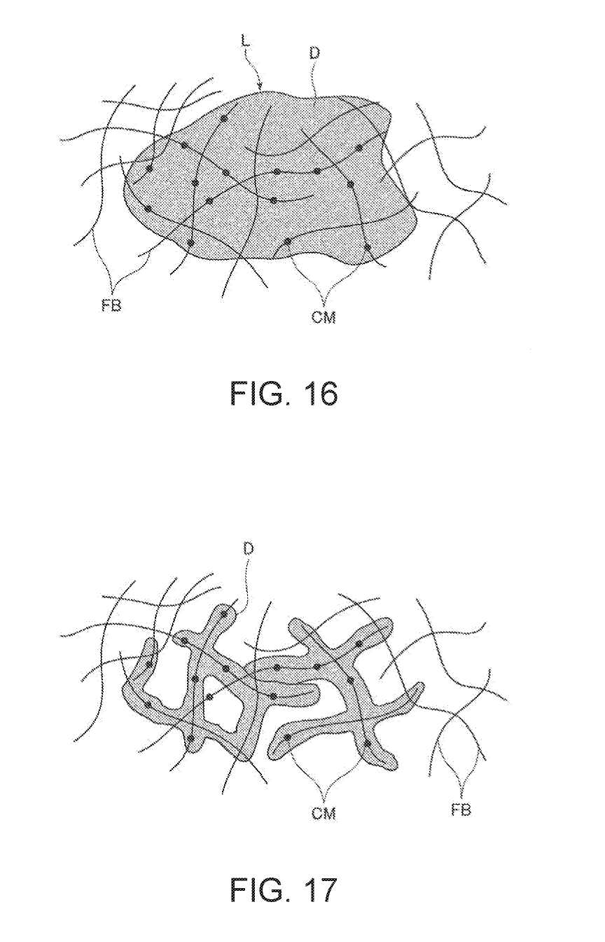

FIG. 15 is a schematic side view showing the configuration of a sheet processing device according to a sixth embodiment of the invention. FIG. 16 is an enlarged view illustrating fiber and color material in the printed part, and illustrates when a refining prevention agent has been applied to the fiber and color material. FIG. 17 is an enlarged view illustrating the fiber and color material in the printed part shown in FIG. 16 after passing through a dryer.

A sixth embodiment of a sheet processing device and a sheet manufacturing apparatus according to the invention is described below with reference to the accompanying figures, focusing on the differences between this and the foregoing embodiments, and omitting or simplifying further description of like elements.

This embodiment is the same as the first embodiment except for the configuration of the processor.

As shown in FIG. 15, the processor 6 in this embodiment has a refining prevention agent applicator 62 that selectively applies to the printed area PA a refining prevention agent D that prevents (suppresses) refining the feedstock M0 (sheet), and a dryer 63 that dries a liquid L (solution, solid dispersion, emulsion, for example) containing the refining prevention agent D.

The refining prevention agent applicator 62 has at least one nozzle 621 and a laminated piezo actuator 612, and ejects a liquid L containing a refining prevention agent D from the nozzle 621 to the printed area PA by an inkjet method. As a result, the refining prevention agent D can be quickly and accurately applied to the printed area PA, and can easily penetrate between the fibers FB. As a result, the fibers FB and color material CM in the printed area PA can be covered with the refining prevention agent D more reliably than a configuration that simply coats the surface with a coater (see FIG. 16). This state can prevent excessive detangling, or more specifically excessive refinement, of the fiber FB in the defibrator 13.

Note that refining as used herein includes both the shredding process of the shredder 12 and the defibration process of the defibrator 13, but in this embodiment refinement is described as the defibration process. Refinement as used in this embodiment therefore means that by processing the sheet material, material can pass through a 1000 micron mesh sieve when processed by in a vibratory sieve shaker (AS200, Retsch) during continuous vibration for 10 minutes at a vibration amplitude of 1 mm or more.

This embodiment can control operation of the refining prevention agent applicator 62 based on the prediction result from the timing predictor 9. As a result, refining prevention agent D can be accurately applied by the refining prevention agent applicator 62 to the printed area PA without excess or deficiency.

Note also that application of the refining prevention agent D to the feedstock M0 is not limited to the printed area PA, and may include areas beyond the printed area PA (such as the entire area (entire surface) of the front of the feedstock M0).

The refining prevention agent D may be a hydrophobic material or a hydrophobic material.

Examples of hydrophilic materials include: polyvinyl alcohol, polyacrylamide (PAM), polymethacrylic acid resin, poly(acrylic acid) resin, starch, carboxymethyl cellulose, hydroxyethyl cellulose, methyl cellulose, hydroxypropyl cellulose, gelatin, pullulan, alginic acid, guar gum, locust bean gum, xanthan gum, pectin, carrageenan, polyamidine, polyethylene oxide, polyacrylamide, polyvinylacetamide, polydioxolane, polyvinylphenol, polyglycerin, (acryloyloxyethyl)trimethyl, ethyleneimine-based resin, polystyrene sulfonate resin, isoprene-based sulfonic acid resin, polyethylene glycol-based resin, polyvinylpyrrolidone-based resin, polymaleic acid-based resin, poly(itaconic acid)-based resin, 2-acrylamido-2-methylpropane sulfonic acid soda-based resin.

When the refining prevention agent D is hydrophilic and the fiber FB is cellulose, binding between the refining prevention agent D and fibers FB can be improved. As a result, refinement of the color material CM and fiber FB in the printed area PA can be more effectively prevented. In addition, water-based solvents and dispersion media can be used, and a liquid L containing a refining prevention agent D can be acquired at low cost.

Examples of hydrophobic materials include polyvinyl acetate-based resin, polyethylene-based resin, polypropylene-based resin, polystyrene-based resin, polyvinyl chloride-based resin, polyethylene terephthalate-based resin, nylon-based resin, polycarbonate-based resin, vinyl acetate-acrylic copolymer, Vinyl acetate ethylene copolymer, styrene acrylic copolymer, acrylic-urethane copolymer, vinyl chloride acrylic copolymer, and vinyl chloride ethylene copolymer.

By using a hydrophobic material, organic solvents can be used as a solvent, and the drying time can be shortened (drying rate can be increased). As a result, drying by the dryer 5 can be accelerated, and the processing rate (throughput) can be increased.

The dryer 63 is located downstream from the refining prevention agent applicator 62, and dries the liquid L containing the refining prevention agent D applied by the refining prevention agent applicator 62.

The dryer 63 has a pair of heat rollers 631 disposed on opposite sides of the thickness of the glue belt 210, and compresses and heats the feedstock M0 passing between the heat rollers 631. This compression and heating process vaporizes the solvent or dispersion medium in the liquid L containing the refining prevention agent D applied to the printed area PA. This also fixes the refining prevention agent D covering the color material CM and fiber FB in the printed area PA (see FIG. 17). As a result, the printed area PA can be prevented from breaking apart into refined material when the feedstock M1 passes the defibrator 13. In other words, the color material CM and fiber FB of the printed part P can be intentionally made to clump together.

Operation of the dryer 63 can also be controlled based on the prediction result from the timing predictor 9. As a result, the printed area PA can be accurately dried by the dryer 63 without excess or deficiency.

Note that depending on the softening point of the refining prevention agent D, the refining prevention agent D can be made to soften in the dryer 63, coat the color material CM and fiber FB in the printed area PA, and more strongly bind the color material CM and fiber FB in the printed area PA.

In the configuration shown in FIG. 15, the dryer 63 is configured to dry by using the heat rollers 631, but the invention is not so limited and may be configured to dry by forced hot air.

Furthermore, if the refining prevention agent D comprises a quick-dry organic solvent, the fiber FB has high absorptivity to the refining prevention agent D, or the amount of refining prevention agent D applied is small, the feedstock M0 may dry quickly at room temperature and the dryer 63 may be omitted.

The processor 6 in this embodiment is configured to apply a liquid L (refining prevention agent D) and dry the liquid L, but the invention is not so limited. For example, the processor 6 may be configured to apply a charged material having the ability to eliminate formation of clumps during defibration, or to apply dry ice or particles with a Mohs hardness greater than or equal to 2 and less than or equal to 5 (such as crushed walnut shells) to promote removal of color material CM.

Embodiments of a sheet processing device and sheet manufacturing apparatus according to the invention as shown in the figures are described above, but the invention is not so limited, and parts of the sheet processing device and sheet manufacturing apparatus may also be replaced with equivalent configurations having the same function. Other configurations may also be added as desired.

In addition, a sheet processing device and sheet manufacturing apparatus according to the invention may be a combination of any two or more desirable configurations (features) of the embodiments described above.

The foregoing embodiments describe configurations in which the used sheets being recycled are printed on one side, but the invention is not so limited and the sheets may be printed on both sides. In this case, both sides may be processed by detecting the printed part of one side and removing that printed area, and then detecting the printed part of the other side and removing that printed area.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosures of Japanese Patent Application No. 2018-052976 filed Mar. 20, 2018 is expressly incorporated herein by reference.

What is claimed is:

1. A sheet processing device comprising:
a conveyor configured to convey a sheet having a printed area that was previously printed;
a position detector configured to detect a location of a specific part of the sheet being conveyed by the conveyor;
a processor configured to execute a specific process on at least the printed area;
a timing predictor configured to predict, based on a detection result from the position detector, when the printed area will reach the processor; and
a controller configured to control operation of the processor based on a prediction result of the timing predictor.

2. The sheet processing device described in claim 1, wherein:
the conveyor has a rotationally supported roller, and an endless belt on which the sheet is placed and which is mounted around the roller; and
the timing predictor has an encoder configured to detect an amount of rotation of the roller, or an amount of movement of the endless belt accompanying rotation of the roller.

3. The sheet processing device described in claim 1, wherein:
the specific area is the printed area; and
the position detector has an imaging device configured to image at least the printed area of the sheet.

4. The sheet processing device described in claim 1, wherein:
the specific part is a leading end located at the front of the sheet in the conveyance direction; and
the position detector has an imaging device configured to image at least the leading end of the sheet.

5. The sheet processing device described in claim 1, wherein:
the specific part is a trailing end located at the back of the sheet in the conveyance direction; and
the position detector has an imaging device configured to image at least the trailing end of the sheet.

6. The sheet processing device described in claim 3, wherein:
the controller has a data processor configured to process data of an image captured by the imaging device.

7. The sheet processing device described in claim 1, wherein:
the processor has an eraser configured to selectively remove at least a surface portion of the printed area.

8. The sheet processing device described in claim 7, wherein:
the eraser has a grinding tool configured to grind the sheet, and a pressure mechanism configured to selectively increase in the printed area contact pressure between the sheet and the grinding tool.

9. The sheet processing device described in claim 1, wherein:
the processor has a color material applicator configured to selectively apply color material to the printed area.

10. The sheet processing device described in claim 1, wherein:
the processor has a refining prevention agent applicator configured to selectively apply to the printed area a refining prevention agent that prevents refinement of the sheet.

11. The sheet processing device described in claim 1, wherein:
the processor is configured to apply by an inkjet method.

12. A sheet manufacturing apparatus comprising:
the sheet processing device described in claim 1;
the sheet manufacturing apparatus making a new sheet using as feedstock the sheet processed by the processor.

13. The sheet processing device described in claim 9, wherein:
the processor is configured to apply by an inkjet method.
